(19) United States
(12) Patent Application Publication
(10) Pub. No.: US 2016/0319574 A1
(43) Pub. Date: Nov. 3, 2016

(54) DOOR STOPPER AND DOOR SECURITY ASSEMBLY

(71) Applicant: Exceptor B.V., R.H Nootdorp (NL)

(72) Inventor: Marco Hazelhorst, RH Nootdorp (NL)

(21) Appl. No.: 14/723,944

(22) Filed: May 28, 2015

(30) Foreign Application Priority Data
Apr. 28, 2015 (EP) 15165417.5

(51) Int. Cl. E05C 1/08; E05B 61/00; E05B 63/22; E05C 19/00

(52) U.S. Cl. CPC E05C 1/08; E05C 19/00; E05B 61/00; E05B 63/22

(57) ABSTRACT

A door stopper includes a substantially tubular and hollow pin housing and a mounting plate fixedly connected to one end of the pin housing, the mounting plate having a recess formed therein and a pin opening at the bottom of the recess and aligned with the inner hollow of the pin housing. A stopper pin is guided through the pin opening of the mounting plate and extends into the inner hollow of the pin housing. A retaining member is arranged in the recess and has an aperture which is aligned with the pin opening and through which the stopper pin extends. The retaining member is hingedly coupled to the mounting plate and spring-loaded so that the opening surface of the aperture is biased in a tilted position and the retaining member exerts a frictional force onto the stopper pin to frictionally lock the stopper pin in the pin housing.

### FIELD OF THE INVENTION

The present invention relates to a door stopper and a door security assembly, specifically for use in buildings with side hung doors to check the door when swung in an opening arc.

### BACKGROUND OF THE INVENTION

Door stoppers, also called doorstops, are objects or structures which are used to keep a door open or closed, or to prevent a door from opening too widely. Door stoppers are commonly used as additional safety measure to door locks in order to prevent unauthorized opening of the door or unwarranted access to a building or room behind the door. Simple door stoppers may be heavy objects that are put before the door body. More elaborate door stoppers may involve brackets or holders mounted to the door itself and blocking the door in its movement around the door hinge.

Safety relevant door stoppers, however, need to provide sufficient resistance against forceful attempts to open the door and gain entry into the building or room behind the door. Moreover, such door stoppers need to be inaccessible from the outside so that a trespasser will not deactivate the door stopper from outside the door. On the other hand, door stoppers are desirably easy to operate and sufficiently failsafe with respect to accidental activation. Finally, door stoppers should conveniently work on all types of doors without the need for specific modification of the door itself.

There have hitherto been many attempts to find solutions for door stoppers in the art: For example, the documents DE 100 22 880 A1, U.S. Pat. No. 2,929,647 A, WO 86/06781 A1, U.S. Pat. No. 3,330,585 A and U.S. Pat. No. 5,395,143 A disclose a variety of door stopper assemblies relying on a post that may be slid into and out of a housing member, thereby realizing different operational positions of the door stoppers. One particular suggestion in the prior art is disclosed in document EP 0 111 034 A1, in which a security stop comprises a vertically extending member movable within a housing and a retaining member that holds the extending member in a locked position by virtue of frictional forces acting between the retaining member and the extending member passing through the retaining member.

### SUMMARY OF THE INVENTION

However, there is a need for improvements in door stoppers which allow for easier and more reliable operation by a user, which are resilient to dirt and contaminants, and which provide a greater mechanical stability in order to exert an optimal jamming or blocking force on the door to be secured.

A first aspect of the disclosure thus pertains to a door stopper, comprising a substantially tubular and hollow pin housing and a mounting plate fixedly connected to one end of the pin housing, the mounting plate having a recess formed therein and a pin opening at the bottom of the recess and aligned with the inner hollow of the pin housing. A stopper pin is guided through the pin opening of the mounting plate and extends into the inner hollow of the pin housing. A retaining member is arranged in the recess and has an aperture which is aligned with the pin opening and through which the stopper pin extends. The retaining member is hingedly coupled to the mounting plate and spring-loaded so that the opening surface of the aperture is biased in a tilted position and the retaining member exerts a frictional force onto the stopper pin to frictionally lock the stopper pin in the pin housing.

According to a second aspect of the disclosure, a door security assembly includes a door stopper according to the first aspect of the disclosure and a number of fastening elements which fix the mounting plate of the door stopper to a floor next to a door.

One idea of those on which the present invention is based is to provide an elongated pin within a pin casing or housing so that the pin may move in a sliding manner between a fully retracted position within the casing and a fully extended position where the pin protrudes from an open top side of the casing. In order to provide control over the positioning of the pin, and thus the operability of such a door stopper, a mounting plate with an aperture encircling the pin is fixedly connected to the casing. The mounting plate includes a retaining member which can be actuated by a user, for example by foot or manually.

In its steady state, the retaining member is held in a biased arrangement so that the aperture is slightly slanted with regard to the pin passing through the aperture. That way, the retaining member exerts a frictional force on the pin holding the pin in place so that it is not able to slidingly move within the casing and through the aperture. Upon actuation, the retaining member is tilted from its biased arrangement towards a position in which the aperture is substantially flush with the diameter of the pin. The frictional force between the inner wall of the aperture and the outer wall of the pin will lessen during actuation until the pin is able to substantially freely move within the casing and through the aperture.

The pin is biased within the casing in the sliding direction so that an actuation of the retaining member and, hence, a release of the pin retracted in the casing will cause the pin to spring outward by virtue of the biasing force into the extended position. If the user wants to set the door stopper back into its inactive or retracted position, he/she will manually exert a countering force to the biasing force on the pin, thereby urging the pin back into the casing in a sliding motion. If the retaining member is released again, the aperture will once again hold the pin within the casing by virtue of the friction between the inner wall of the aperture and the outer wall of the pin.

A particular advantage of the door stopper according to the invention is the recessed mounting plate in which the retaining member is securely held in place. In contrast to the retaining plate of document EP 0 111 034 A1 which is merely bolted on top of the mounting plate of the housing sunk into the floor, the retaining member of the door stopper according to the invention is hingedly suspended within the recess.

This provides several advantages over the prior art: First of all, the hinged connection is mechanically more stable since the hinge pivot bearing may be suspended at two opposite points in the inner walls of the recess. Therefore, the blocking force that is applied by the door stopper before it eventually gives in to displacement forces, for example by an intruder trying to shove open the door by brute force, is much larger. Secondly, the moving parts of the retaining mechanism may be completely accommodated within the mounting plate. Any dirt, humidity or contaminant particles will therefore be kept out of the retaining mechanism, thereby improving the reliability and operability of the retaining mechanism. Thirdly, the retaining member may be implemented essentially flush with the remaining upper surface of the mounting plate. This levies the problem of parts of the door stopper standing out or protruding from the floor where the door stopper is installed, thereby decreasing the risk of accidentally and unwantedly activating the door stopper or bumping into the door stopper which may potentially lead to damage to the retaining mechanism or injuries of feet and toes.

Advantageous variations and modifications of the door stopper and the door security assembly are set out in the appended dependent claims.

According to an embodiment of the door stopper, the mounting plate may further comprise a hinge pivot bearing in which a hinge pivot is arranged to hingedly couple the retaining member to the mounting plate. According to a further embodiment of the door stopper, the mounting plate may further comprise a retaining spring in the recess on a side of the pin opening opposite to the side where the hinge pivot bearing is located, the retaining spring spring-loading the retaining member against the mounting plate. Such an arrangement is particularly, since the retaining spring is completely beneath the retaining member and within the recess. Mechanically fragile parts such as springs are susceptible to wear or failure upon corrosion or jamming particles, so the retaining spring of the inventive door stopper is optimally secured against external detrimental influences.

According to a further embodiment of the door stopper, the mounting plate may further comprise bolting holes outside the diameter of the pin housing.

According to a further embodiment of the door stopper, the door stopper may further comprise a biasing member arranged within and fixedly connected to the pin housing, the biasing member coupled to the stopper pin so that the stopper pin is biased in an extending position where the stopper pin protrudes at least partially out of the pin housing. This extending position is a mechanically steady state so that the door stopper passively and reliably can block a door from swinging open.

According to a further embodiment of the door stopper, the stopper pin may be configured to be pushed against a biasing force of the biasing member into the pin housing. In this regard, the frictional force of the retaining member in the frictional lock may exceed the biasing force of the biasing member against the stopper pin when the stopper pin is pushed into the pin housing. This enables the stopper pin to be stowed away in a retracted or inactive position, while extending the stopper pin does not require any pulling force. On the other hand, deactivating the door stopper again simply requires a user to push the stopper pin into the housing without much effort.

According to a further embodiment of the door stopper, the door stopper may further comprise a housing cap which is plugged into the pin housing on the opposite side of the mounting plate. The housing cap may advantageously seal the tubular pin housing from the bottom side, thereby avoiding humidity or contaminant particles entering the housing and jamming the door stopper.

According to a further embodiment of the door stopper, the stopper pin may comprise a substantially cylindrical pin body. Alternatively, the stopper pin may comprise a substantially cuboid pin body. In both cases, embodiments of the door stopper may involve a stopper pin with a pin cap connected to the pin body, the pin cap having a diameter which is larger than the diameter of the pin body. Such stopper pins are convenient for operation by foot since the pin cap provides a broadened surface on which a user may step with his foot, thereby avoiding uncomfortable focussed pressure on the sole of the foot during deactivation of the door stopper.

According to an embodiment of the door security assembly, the pin housing of the door stopper may be completely sunk into the floor. The mounting plate may then be substantially flush with the surface of the floor. Such a door security assembly allows for securing doors which only have a small gap between the bottom side of the door body and the floor, since the door stopper does not stand out from the surface of the floor in its retracted state. Moreover, the door security assembly does not constitute an inconvenient obstacle when walking over or going by wheelchair through the opened door.

According to a further embodiment of the door security assembly, the door security assembly may further comprise a door protection member which is mountable to a door and which is configured to receive the stopper pin in its extended position when the door is opened and pushed against the stopper pin. The door protection member avoids damage to the door body when the door is pushed into the stopper pin. In some situations, the door stopper may also be used as device for slightly holding the door open without allowing the door to be completely opened, for example when a room is to be aired through the door, while the room is unattended. The door protection member may then receive the stopper pin and hold it in a snap-fit engagement. The door will then stay open just a slight bit, and neither will an intruder be able to open the door completely nor will there be a risk that the door is accidentally slammed shut by a gust of wind.

### BRIEF DESCRIPTION OF THE DRAWINGS

The invention will be explained in greater detail with reference to exemplary embodiments depicted in the drawings as appended.

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 schematically illustrates an exploded view of a door stopper according to an embodiment of the invention.

FIG. 2 schematically illustrates an isometric view of the assembled door stopper of FIG. 1 in a retracted position.

FIG. 3 schematically illustrates an orthographic projection of the assembled door stopper of FIG. 1 in a retracted position.

FIG. 4 schematically illustrates a section view of the door stopper of FIG. 3.

FIG. 5 schematically illustrates an isometric view of the assembled door stopper of FIG. 1 in an extended position.

FIG. 6 schematically illustrates an orthographic projection of the assembled door stopper of FIG. 1 in an extended position.

FIG. 7 schematically illustrates a section view of the door stopper of FIG. 6.

FIG. 8 schematically illustrates an exploded view of a door stopper according to another embodiment of the invention.

FIG. 9 schematically illustrates an isometric view of the assembled door stopper of FIG. 8 in an extended position.

FIG. 10 schematically illustrates an exploded view of a door stopper according to yet another embodiment of the invention.

FIG. 11 schematically illustrates an isometric view of the assembled door stopper of FIG. 10 in an extended position.

FIG. 12 schematically illustrates an orthographic projection of the assembled door stopper of FIG. 10 in an extended position.

FIG. 13 schematically illustrates a section view of the door stopper of FIG. 12.

### DETAILED DESCRIPTION OF THE INVENTION

In the figures, like reference numerals denote like or functionally like components, unless indicated otherwise. Any directional terminology like “top”, “bottom”, “left”, “right”, “above”, “below”, “horizontal”, “vertical”, “back”, “front”, and similar terms are merely used for explanatory purposes and are not intended to delimit the embodiments to the specific arrangements as shown in the drawings.

Although specific embodiments have been illustrated and described herein, it will be appreciated by those of ordinary skill in the art that a variety of alternate and/or equivalent implementations may be substituted for the specific embodiments shown and described without departing from the scope of the present invention. Generally, this application is intended to cover any adaptations or variations of the specific embodiments discussed herein.

The door stoppers and door security kits as disclosed hereinforth may be used in a lot of applications, including—but not limited to—securing entrance doors of buildings against unsolicited opening, providing a stoppage mechanism only to be released from the inside of a door, allowing doors to stand ajar with a slight gap without the possibility of entering through the door and similar. While the door stoppers are disclosed throughout this specification as being designed to stop doors from opening more than just slightly, it is to be understood that the door stoppers as illustrated and explained hereinbelow may also be employed for blocking other hinged objects from swinging in an arc around the hinge, such as for example hinged windows, tilt-and-turn windows or other movable hinge-jointed objects.

The door stoppers and door security kits may advantageously be used to prevent burglary attempts or otherwise unwarranted access of unauthorized persons to a premise the doors of which are secured by the door stoppers as disclosed herein. The door stoppers may particularly be used for installation into the floor before the door to be secured. The door stopper's casing may in this case be fully sunken into a bore or recess in the floor so that the upper surface of the door stopper in its retracted position is substantially flush with the surface of the floor, thereby enabling the door to be freely swung over the retracted and thus inactive door stopper. In its securing position, the pin of the door stopper may be extended from the sunken casing so as to protrude from the surface of the floor and act as a mechanical check or block for the door to be secured.

A door security assembly may comprise a door stopper, such as one of the door stoppers 10, 20 or 30 as illustrated and explained in conjunction with the appended drawings. Furthermore, the door security assembly may include a number of fastening elements, such as bolts or screws which may be used to fix the mounting plate of the door stopper to a floor, particularly in a floor portion next to a door that lies in the area which is swept over by the opening door. The choice of the positioning on the floor with respect to the door may determine the angle up to which the door may be opened when the door stopper is put into active, i.e. extending position. The pin housing of the door stopper may be completely sunken into the floor so that the mounting plate is substantially flush with the surface of the floor.

Door security assemblies may further include a door protection member that can be mounted to the door to be secured. The door protection member may for example be a small plastic bracket that may be able to receive the stopper pin in its extended position when the door is opened and pushed against the stopper pin. Such a plastic bracket may for example provide for a snap-fit engagement between the stopper pin and the door protection member to releasably engage the door with the door stopper for temporarily fixing the door in a slightly open position. Alternatively, the door protection member may be a simple foam cushion that may absorb the shock when the door is pushed against the extended stopper pin.

Of course, it may also be possible to install the door stopper in a wall near the door or in the ceiling above the door. In both cases, the installation will be made in such a way that the door stopper with the pin retracted does not provide a block or check for the door swinging past the door stopper, while the extended pin of the door stopper extends into the movement path of the swinging door, thereby effectively preventing it from being swung open.

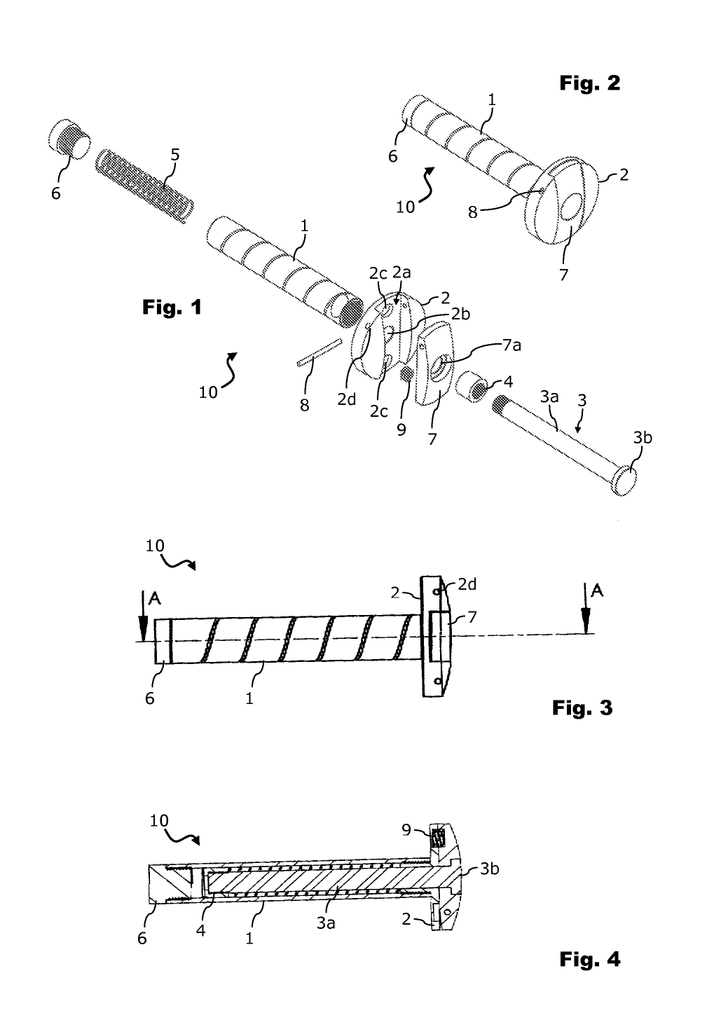

FIG. 1 shows a schematic illustration of an exploded view of a door stopper 10 according to a first embodiment of the invention. The door stopper 10 of FIG. 1 is again shown in FIG. 2 in assembled form, wherein the door stopper 10 is drawn in a retracted position. FIG. 3 schematically illustrates an orthographic projection of the assembled door stopper 10 of FIG. 1 in such a retracted position, with FIG. 4 illustrating a cross section through the door stopper 10 of FIG. 3 along the section line A-A.

The door stopper 10 comprises a substantially tubular and hollow pin housing 1 which may for example be made from steel, aluminium or reinforced plastic. A mounting plate 2 is fixedly connected to one end of the pin housing 1, for example by welding a metal plate to the rim of the housing tube. The mounting plate 2 may as well be made from steel or aluminium. The mounting plate 2 may have a flat surface or a slightly rounded surface, as shown in the figures. Generally the mounting plate 2 may have a flange that extends over the diameter of the pin housing 1. The mounting plate 2 may have further one or more bolting holes 2c which are bored through the mounting plate 2 outside the diameter of the pin housing 1. For example and as exemplarily illustrated in the figures, the bolting holes 2c may be formed at the bottom of a recess 2a formed in the mounting plate 2.

The bottom of the pin housing 1 may be optionally sealed off by a housing cap 6 which is plugged into the pin housing 1 on the opposite side of the mounting plate 2. The housing cap 6 may for example be threadingly engaged with a corresponding threaded inner surface of the pin housing 1 in the region of the bottom end.

The recess may for example have an essentially rectangular shape and may be formed with a pin opening 2b at the bottom of the recess 2a. The pin opening 2b is a via that has similar size as the pin housing 1 and is aligned with the inner hollow of the pin housing 1. A stopper pin 3 is guided through the pin opening 2b of the mounting plate 2, thereby be able to slide in and out of the pin housing 1. In that way, the stopper pin 3 may extend into the inner hollow of the pin housing 1 by a varying degree. The stopper pin 3 may include a generally cylindrical pin body 3a with a smooth outer surface and a pin cap 3b connected to the pin body 3a. The pin cap 3b has a diameter which is larger than the diameter of the pin body 3a and may for example have a rounded top surface so that stepping on top of the pin cap 3b by foot does not leave an unpleasant feeling for the user. The pin body 3a and pin cap 3b may for example be manufactured from metal such as steel or aluminium.

The door stopper 10 further comprises a retaining member 7 that is arranged in the recess 2a. The retaining member 7 may have an outer shape that generally corresponds in for to the outer shape of cut-out portion of the recess 2a. The retaining member 7 has an aperture 7a formed therethrough which is aligned with the pin opening 2b. The stopper pin 3 extends through the aperture 7a and then through the pin opening 2b into the pin housing 1.

The retaining member 7 is hingedly coupled to the mounting plate 2, for example by means of a hinge pivot 8. The hinge pivot 8 may be a thin rod that extends through a corresponding through-hole in the retaining member 7 and is hinged in two adjacent hinge pivot bearings 2d in the inner walls of the recess 2a. The hinge pivot 8 hingedly couples the retaining member 7 to the mounting plate 2, i.e. the retaining member 7 is able to be tilted out of axis of the pin housing 1.

A retaining spring 9 may be fixedly arranged in the recess 2a on a side of the pin opening 2b opposite to the side where the hinge pivot bearing 2d is located. The retaining spring 9 spring-loads the retaining member 7 against the mounting plate 2 so that the opening surface of the aperture 7a is biased in a tilted position with respect to the pin opening 2b. That way, the retaining member 7, and particularly the inner walls of the aperture 7a, will exert a frictional force onto the stopper pin 3 when being in its spring-loaded steady state. In that state, the retaining member frictionally locks the stopper pin 3 in its current position with regard to the pin housing 1.

The pin housing 1 is further equipped with a biasing member 5 located therein. The biasing member 5 may for example be a further spring that is arranged within and fixedly connected to the pin housing 1. The biasing member 5 may for example be secured to the housing cap 6 of the pin housing 1. The biasing member 5 is coupled to the stopper pin 3 so that the stopper pin 3 is biased in an extending position where the stopper pin 3 protrudes at least partially out of the pin housing 1. The stopper pin 3 may be pushed against the biasing force of the biasing member 5 into the pin housing 1. If the frictional force of the retaining member 7 in the frictional lock exceeds the biasing force of the biasing member 5 against the stopper pin 3, the stopper pin 3 will always remain in its actual position with regard to the pin housing 1 as long as the retaining member 7 is not actuated upon, i.e. when retaining member 7 is in its steady state. This allows for realisation of a retracted or inactive state of the door stopper 10 where the stopper pin 3 is completely pushed into the pin housing 1, i.e. does not protrude over the top surface of the mounting plate 2.

When the retaining member 7 is actuated, i.e. when the retaining member 7 is pushed downward against the biasing force of the retaining spring 9, the retaining member 7 will slightly rotate around the hinge pivot 8. This gradually brings the aperture 7a out of its tilted position with regard to the pin opening 2b. In other words, the effective passage area for the stopper pin 3 through the aperture 7a when seen in the direction of the main axis of the stopper pin 3 increases gradually as well. In turn, the frictional force that is exerted by the inner walls of the aperture 7a on the stopper pin 7 gradually decreases upon rotation of the retaining member 7, up to the point where the biasing force of the biasing member 5 exceeds the remaining percentage of the frictional force. Thus, the biasing member 5 will push out the stopper pin 3 from the pin housing 1. The strength of the biasing member 5 may be implemented such that the weight of the stopper pin 3 may be pushed out of the pin housing 1, even against the gravitational force when the door stopper 10 is installed in an upright position with the pin housing located in the floor.

If the retaining member 7 is held down long enough, the stopper pin 3 will fully extend out of the pin housing 1, or at least as far as a bearing 4 installed at the bottom of the stopper pin 3 will allow the stopper pin 3 to stick out. The height of the bearing 4 in relation to the length of the pin housing 1 and/or the length of the stopper pin 3 may be chosen according to desired height that the stopper pin 3 should protrude from the top surface of the mounting plate 2 when fully extended.

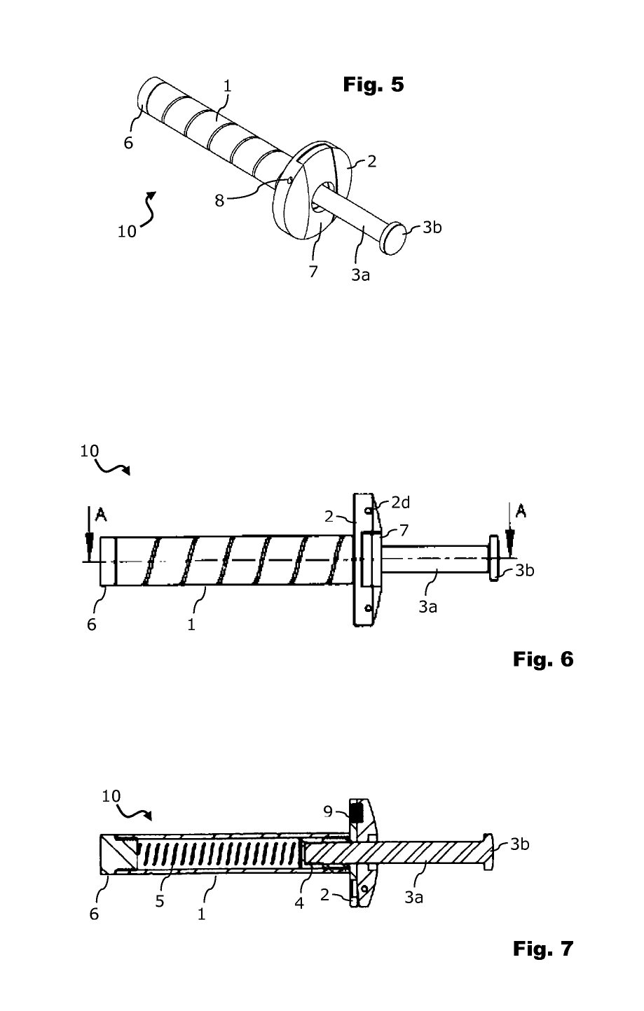

As illustrated in the isometric view of FIG. 5, the door stopper 10 may be brought from the retracted position into a fully extended position, i.e. a working position. FIG. 6 schematically illustrates an orthographic projection of the assembled door stopper 10 of FIG. 1 in such an extended position, with FIG. 7 illustrating a cross section through the door stopper 10 of FIG. 6 along the section line A-A.

Optionally, the frictional locking mechanism of the door stopper 10 may allow for gradual variation of the portion of the stopper pin 3 that protrudes from the top surface of the mounting plate 2. When the stopper pin 3 is only partly pushed into the pin housing 1 and the retaining member 7 is released into its steady state position, the aperture 7 will frictionally lock the pin body 3a of the stopper pin 3 in partly extended position.

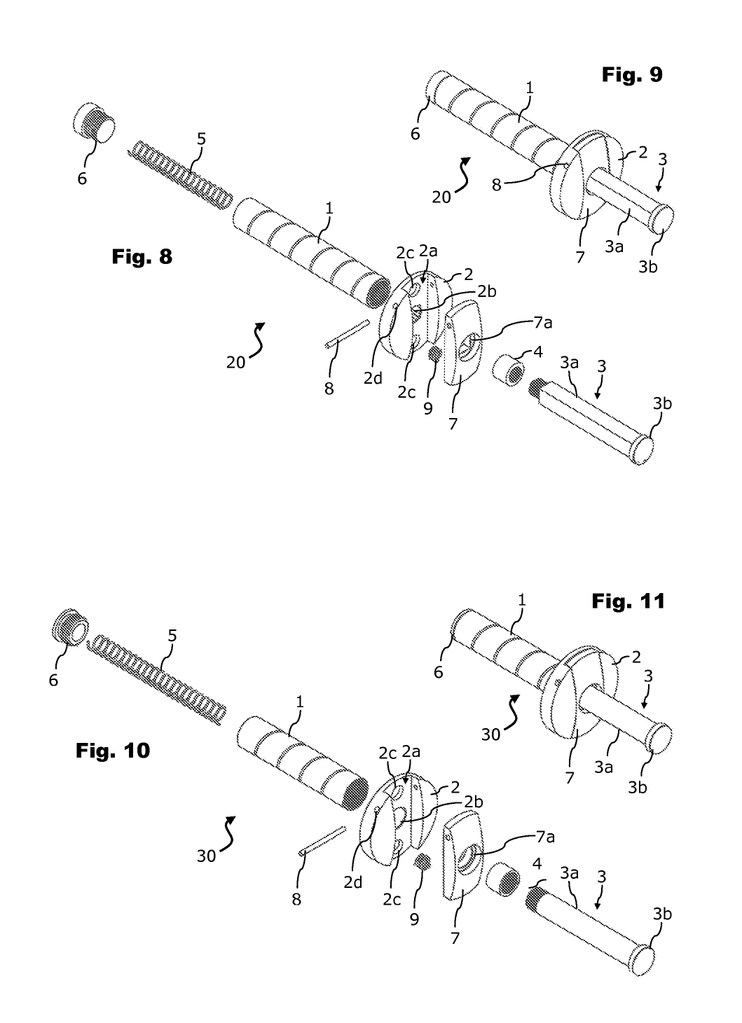

FIG. 8 shows a schematic illustration of an exploded view of a door stopper 20 according to a second embodiment of the invention. The door stopper 20 of FIG. 8 is again shown in FIG. 9 in assembled form, wherein the door stopper 20 is drawn in a retracted position.

The door stopper 20 of FIGS. 8 and 9 differs from the door stopper 10 as illustrated in conjunction with FIGS. 1 to 7 mainly in that the pin body 3a has a substantially cuboid shape, i.e. the pin body 3a has a rectangular or square cross-section.

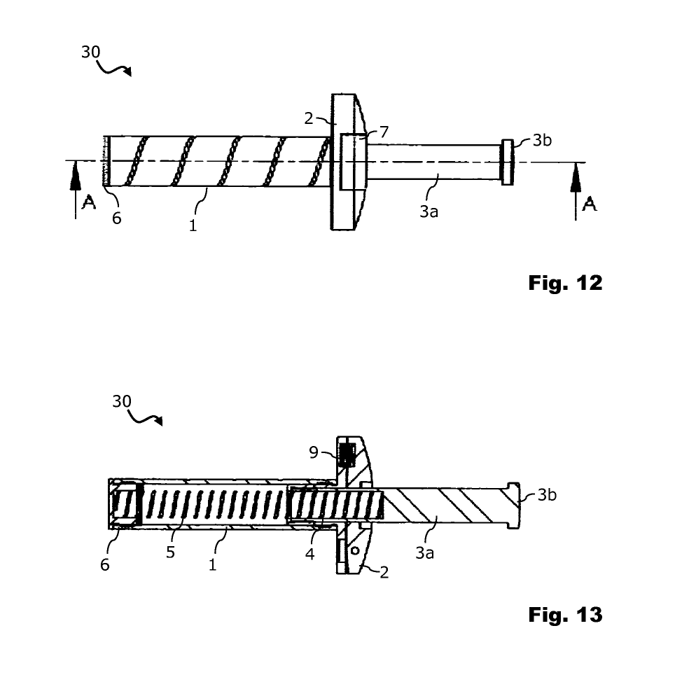

Finally, FIG. 10 shows a schematic illustration of an exploded view of a door stopper 30 according to a third embodiment of the invention. The door stopper 30 of FIG. 10 is again shown in FIG. 11 in assembled form, wherein the door stopper 30 is drawn in a retracted position. FIG. 12 schematically illustrates an orthographic projection of the assembled door stopper 30 of FIG. 10 in such a retracted position, with FIG. 13 illustrating a cross section through the door stopper 30 of FIG. 12 along the section line A-A.

The door stopper 30 of FIGS. 10 to 13 differs from the door stopper 10 as illustrated in conjunction with FIGS. 1 to 7 mainly in that the biasing member 5 is smaller in diameter than the stopper pin 3. The stopper pin 3 of the door stopper 30 may be hollow or at least partly hollow in the bottom portion of the pin body 3a so that the biasing member 5 may at least partly protrude into the stopper pin 3.

In the foregoing detailed description, various features are grouped together in one or more examples or examples with the purpose of streamlining the disclosure. It is to be understood that the above description is intended to be illustrative, and not restrictive. It is intended to cover all alternatives, modifications and equivalents. Many other examples will be apparent to one skilled in the art upon reviewing the above specification.

The embodiments were chosen and described in order to best explain the principles of the invention and its practical applications, to thereby enable others skilled in the art to best utilize the invention and various embodiments with various modifications as are suited to the particular use contemplated. In the appended claims and throughout the specification, the terms “including” and “in which” are used as the plain-English equivalents of the respective terms “comprising” and “wherein,” respectively. Furthermore, “a” or “one” does not exclude a plurality in the present case.

What is claimed is:

1. A door stopper, comprising:
a substantially tubular and hollow pin housing;
a mounting plate fixedly connected to one end of the pin housing, the mounting plate having a recess formed therein and a pin opening at the bottom of the recess and aligned with the inner hollow of the pin housing;
a stopper pin guided through the pin opening of the mounting plate and extending into the inner hollow of the pin housing; and
a retaining member arranged in the recess and having an aperture which is aligned with the pin opening and through which the stopper pin extends,
wherein the retaining member is hingedly coupled to the mounting plate and spring-loaded so that the opening surface of the aperture is biased in a tilted position and the retaining member exerts a frictional force onto the stopper pin to frictionally lock the stopper pin in the pin housing.

2. The door stopper according to claim 1, wherein the mounting plate further comprises a hinge pivot bearing in which a hinge pivot is arranged to hingedly couple the retaining member to the mounting plate.

3. The door stopper according to claim 2, wherein the mounting plate further comprises a retaining spring in the recess on a side of the pin opening opposite to the side where the hinge pivot bearing is located, the retaining spring spring-loading the retaining member against the mounting plate.

4. The door stopper according to claim 1, wherein the mounting plate further comprises bolting holes outside the diameter of the pin housing.

5. The door stopper according to claim 1, further comprising:
a biasing member arranged within and fixedly connected to the pin housing, the biasing member coupled to the stopper pin so that the stopper pin is biased in an extending position where the stopper pin protrudes at least partially out of the pin housing.

6. The door stopper according to claim 5, wherein the stopper pin is configured to be pushed against a biasing force of the biasing member into the pin housing.

7. The door stopper according to claim 6, wherein the frictional force of the retaining member in the frictional lock exceeds the biasing force of the biasing member against the stopper pin when the stopper pin is pushed into the pin housing.

8. The door stopper according to claim 1, further comprising:
a housing cap which is plugged into the pin housing on the opposite side of the mounting plate.

9. The door stopper according to claim 1, wherein the stopper pin comprises a substantially cylindrical pin body.

10. The door stopper according to claim 1, wherein the stopper pin comprises a substantially cuboid pin body.

11. The door stopper according to claim 9, wherein the stopper pin comprises a pin cap connected to the pin body, the pin cap having a diameter which is larger than the diameter of the pin body.

12. The door stopper according to claim 10, wherein the stopper pin comprises a pin cap connected to the pin body, the pin cap having a diameter which is larger than the diameter of the pin body.

13. A door security assembly, comprising:
a door stopper, comprising
a substantially tubular and hollow pin housing;
a mounting plate fixedly connected to one end of the pin housing, the mounting plate having a recess formed therein and a pin opening at the bottom of the recess and aligned with the inner hollow of the pin housing;
a stopper pin guided through the pin opening of the mounting plate and extending into the inner hollow of the pin housing; and
a retaining member arranged in the recess and having an aperture which is aligned with the pin opening and through which the stopper pin extends,
wherein the retaining member is hingedly coupled to the mounting plate and spring-loaded so that the opening surface of the aperture is biased in a tilted position and the retaining member exerts a frictional force onto the stopper pin to frictionally lock the stopper pin in the pin housing; and
a number of fastening elements which fix the mounting plate of the door stopper to a floor next to a door.

14. The door security assembly according to claim 13, wherein the pin housing of the door stopper is completely sunk into the floor, and wherein the mounting plate is substantially flush with the surface of the floor.

15. The door security assembly according to claim 13, further comprising:
a door protection member which is mountable to a door and which is configured to receive the stopper pin in its extended position when the door is opened and pushed against the stopper pin.

16. The door security assembly according to claim 15, wherein the door protection member is configured to receive the stopper pin in its extended position in a snap-fit engagement.
